(19) United States
(12) Patent Application Publication
(10) Pub. No.: US 2011/0222538 A1
(43) Pub. Date: Sep. 15, 2011

(54) Method and System for L3 Bridging Using L3-To-L2 Mapping Database

(76) Inventors: Bijendra Singh, Plano, TX (US); Arun Saha, Sunnyvale, CA (US); Snigdho Chandra Bardalai, Plano, TX (US)

(21) Appl. No.: 12/723,087

(22) Filed: Mar. 12, 2010

(51) Int. Cl. H04L 12/56

(52) U.S. Cl. 370/392

(57) ABSTRACT

A method may include creating an L3-L2 database on a first switch, the database having one or more entries, each entry: (a) associating a Level 3 (L3) unique identifier associated with a virtual local area network (VLAN) communicatively coupled to the first switch to a Level 2 (L2) unique identifier associated with the VLAN, and (b) associating the L3 unique identifier with a port of the first switch. The method may also include receiving a network packet at the first switch. The method may additionally include determining if a destination VLAN for the network packet has a corresponding entry in the L3-L2 database. The method may further include switching the network packet to the port in response to a determination that the destination VLAN for the network packet has a corresponding entry in the L3-L2 database, such that the packet is communicated to one of: (a) the destination VLAN, and (b) a second switch intermediate to the first switch and the destination VLAN.

### TECHNICAL FIELD OF THE INVENTION

The present invention relates generally to networked communications and, more particularly, to a method and system for L3 bridging using one or more L3-to-L2 mapping databases.

### BACKGROUND

In telecommunications, information is often sent, received, and processed according to the Open System Interconnection Reference Model (OSI Reference Model or OSI Model). In its most basic form, the OSI Model divides network architecture into seven layers which, from top to bottom, are the Application, Presentation, Session, Transport, Network, Data-Link, and Physical Layers, which are also known respectively as Layer 7 (L7), Layer 6 (L6), Layer 5 (L5), Layer 4 (L4), Layer 3 (L3), Layer 2 (L2), and Layer 1 (L1). It is therefore often referred to as the OSI Seven Layer Model.

Layer 2 is the layer which typically transfers data between adjacent network nodes in a wide area network or between nodes on the same local area network segment. Layer 2 provides the functional and procedural means to transfer data between network entities and might provide the means to detect and possibly correct errors that may occur in the Layer 1. Examples of Layer 2 protocols are Ethernet for local area networks (multi-node), the Point-to-Point Protocol (PPP), HDLC and ADCCP for point-to-point (dual-node) connections. Layer 2 data transfer may be handled by devices known as switches.

Layer 3 is responsible for end-to-end (source to destination) packet delivery including routing through intermediate hosts, whereas Layer 2 is responsible for carrying Layer 3 packets of payloads and enabling communication between Layer 3 entities. Perhaps the best known example of a Layer 3 protocol is Internet Protocol (IP). Layer 3 data transfer may be handled by devices known as routers.

In many network configurations, and particularly in metropolitan networks, Layer 2 switches may have one or more virtual local area networks (VLANs) coupled to their ports. From an L3 communication and addressing perspective, an L2 network is accessible through a router. Separate L2 networks typically use separate VLANs. Accordingly, such data must typically be communicated through at least one L3 router, as L2 switches are typically unable to perform switching of L3 packets. Thus, two VLANs may be coupled to or associated with the same L2 switch, but an L3 packet with its destination outside of the originating VLAN may have to travel from the first VLAN, hop through numerous L2 switches until it reaches an L3 router. The L# router may perform inter-VLAN routing for the packet. The packet may again hop through numerous L2 switches until it reaches the destination VLAN. Such lengthy network paths may be undesirable, as the path length may add undesirable delay to communications.

To reduce the path length, network architectures may include additional routers (e.g., replacing some L2 switches with L3 routers). However, such a solution may be undesirable, as it may add increased cost and complexity to a network architecture.

### SUMMARY

In accordance with the present invention, disadvantages and problems associated with communication of inter-VLAN L3 network traffic may be reduced or eliminated.

A method may include creating an L3-L2 database on a first switch, the database having one or more entries, each entry: (a) associating a Level 3 (L3) unique identifier associated with a virtual local area network (VLAN) communicatively coupled to the first switch to a Level 2 (L2) unique identifier associated with the VLAN, and (b) associating the L3 unique identifier with a port of the first switch. The method may also include receiving a network packet at the first switch. The method may additionally include determining if a destination VLAN for the network packet has a corresponding entry in the L3-L2 database. The method may further include switching the network packet to the port in response to a determination that the destination VLAN for the network packet has a corresponding entry in the L3-L2 database, such that the packet is communicated to one of: (a) the destination VLAN, and (b) a second switch intermediate to the first switch and the destination VLAN.

Certain embodiments of the invention may provide one or more technical advantages. For example, certain embodiments may allow for snooping of ARP protocol messages may permit creation of a L3-L2 database that in turn may permit L3 bridging using L2 switches, potentially decreasing cost and complexity of a network implementation.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawing, in which:

FIG. 1 illustrates a block diagram of an example network, in accordance with certain embodiments of the present disclosure; and

FIGS. 2A and 2B illustrate a table depicting an example L3-to-L2 database, in accordance with certain embodiments of the present disclosure.

### DETAILED DESCRIPTION

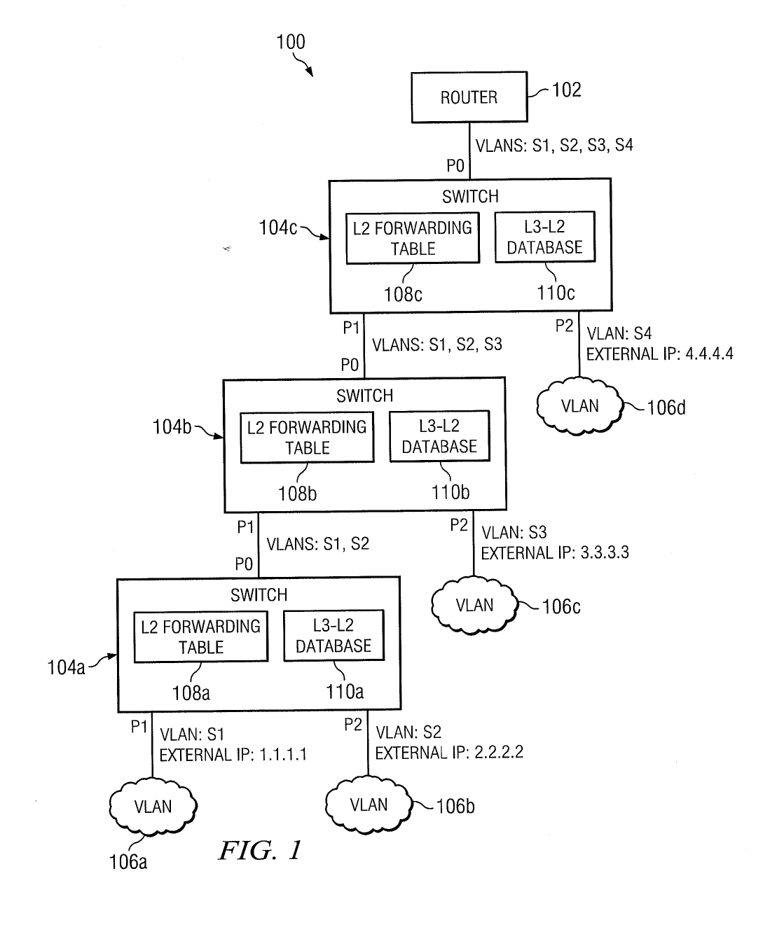

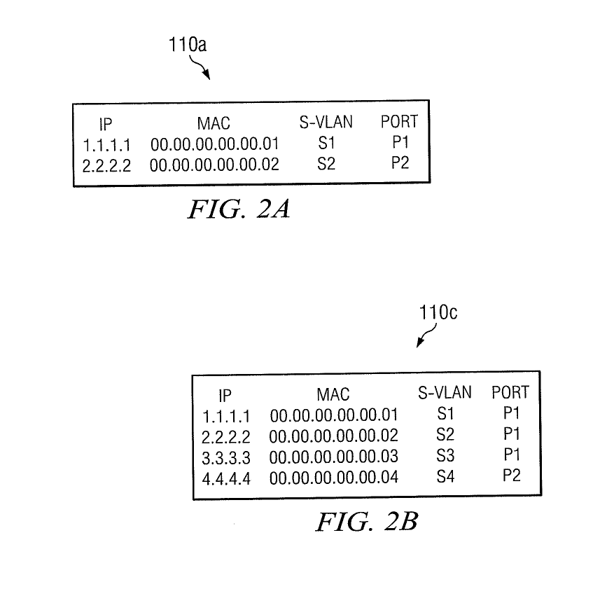

Embodiments of the present invention and its advantages are best understood by referring to FIGS. 1-2B, like numerals being used for like and corresponding parts of the various drawings.

FIG. 1 illustrates a block diagram of an example network 100, in accordance with certain embodiments of the present disclosure. Network 100 may also be configured as a mesh network, ring network, a point-to-point network, or any other suitable network or combination of networks. Network 100 may be used in a short-haul metropolitan network, a long-haul inter-city network, or any other suitable network or combination of networks. As shown in FIG. 1, network 100 may include an L3 router 102, one or more L2 switches 104 (e.g., switches 104a, 104b, 104c), and one or more virtual local area networks (VLANs) 106 (e.g., VLANs 106a, 106b, 106c, 106d).

Router 102 may be communicatively coupled to switches 104 and/or other routers, and may include any system, device or apparatus configured to forward L3 packets in network 100. In some embodiments, router 102 may comprise a metropolitan router.

A switch 104 may be communicatively coupled to one or more routers 102 and/or other switches 104, and may include any system, device or apparatus configured to forward L2 frames in network 100. In some embodiments, a switch 104 may include a metropolitan Ethernet switch. As shown in FIG. 1, a switch 104 may include an L2 forwarding table 108 (e.g., forwarding table 108a, 108b, 108c) and an L3-L2 database 110 (e.g., L3-L2 database 110a, 110b, 110c). An L2 forwarding table 108 of a switch 104 may include a table, map, database, or other data structure for associating each port of such switch 104 with one or more other network entities (e.g., a router 102 and/or another switch 104) using media access control (MAC) addresses, VLAN information, and/or other appropriate information. For example, L2 forwarding table 108a may associate router 102 with port P0 of switch 104a, as data communicated to router 102 from switch 108a must be switched to port P0 (as such data must also travel through switches 104b and 104c). Accordingly, an L2 forwarding table 108 may be used by its associated switch to switch data in network 100.

An L3-L2 database 110 may include a table, map, database, or other data structure for associating an L3 unique identifier (e.g., an IP address) associated with a particular VLAN 106 to an L2 unique identifier (e.g., a Media Access Control (MAC) address, service VLAN address, etc.) associated with the same VLAN. In some embodiments, an L3-L2 database 110 may also include information associating a particular port of a switch 104 with the particular VLAN 106. Example L3-L2 databases 110 are depicted in FIGS. 2A and 2B. The example L3-L2 database 110 shown in FIG. 2A may represent L3-L2 database 110a of switch 104a. As shown in FIG. 2A, an external IP address (L3 unique identifier) for VLAN 106a may be associated with a MAC address (L2 unique identifier) and/or SVLAN (L2 unique identifier) for VLAN 106a. The external IP address may also be associated with the particular port (e.g., P1) of switch 104a to which VLAN 106a may be coupled or reachable. The example L3-L2 database 110 shown in FIG. 2B may represent L3-L2 database 110c of switch 104c.

In some embodiments, an L3-L2 database 110 of a switch 104 may be built by passively snooping address resolution protocol (ARP) packets communicated through the switch 104. ARP is a networking protocol for determining a network entity's (e.g., VLAN) L2 address when only its L3 address is known, and ARP packets are commonly generated as part of regular network operations in many networks.

A VLAN 106 may be coupled to a switch 104 and may include a group of hosts or nodes with a common set of requirements that communicate as if they were attached to the same broadcast domain, regardless of their physical location (e.g., a VLAN 106 may have the same attributes as a physical LAN).

In operation, each switch 104 may snoop ARP messages in order to create and populate its associated L3-L2 database 110. In addition, when a switch 104 receives a packet it first looks at its associated L3-L2 database 110 to determine if an entry exists in the associated L3-L2 database 110 for the destination VLAN 106. If an entry exists, switch 104 may use the information in the associated L3-L2 database 110 to translate the L3 unique identifier (e.g., IP address) of the inter-VLAN packet into an L2 unique identifier (e.g., MAC address), and then switch the packet to the destination address based on the L2 unique identifier and/or the specified port number, thus creating an L3 bridge without the need for an L3 router 102. When packets are switched using L3-L2 database 110, the packet's VLAN may be modified to the destination VLAN and other actions (e.g., recalculation of checksum) may be performed. If a switch 104 receives a packet an entry for the destination VLAN does not exist in associated L3-L2 database 110, switch 104 may then switch (e.g., according to entries in its L2 forwarding table 108) the packet to a router 102 or another switch 104 communicatively coupled to a router 102 such that the packet may be further switched to a router 102, or switched by an L3 bridge at another switch 104.

As a specific example, assume that a packet is to be communicated from VLAN 106a to VLAN 106b. In traditional approaches, such packet would be switched through switches 104a, 104b and 104c to router 102, and from router 102 back through switches 104c, 104b, and 104a before reaching its destination at VLAN 106b. However, using the methods and systems disclosed herein, the packet may be received on switch 104a via port P1, and switch 104a may then determine if an entry exists in L3-L2 database 104a for destination VLAN 106b. If an entry exists, the packet would be switched through port P2 of switch 104a to destination VLAN 106b based on the information in L3-L2 database 104a. If an entry does not exist, the packet may be switched to switch 104b. At switch 104b, another determination may be made regarding whether an entry exists in L3-L2 database 110b. If an entry exists, the packet may be switched in accordance with L3-L2 database 104b. A similar process may be repeated at each switch 104 until: (a) a router 102 is reached, at which point the packet is routed by router 102, or (b) a corresponding entry for a destination VLAN 106 is found in an L3-L2 database 110, and the packet is appropriately routed to such destination VLAN 106 through one or more switches.

As another example, a network packet traveling between VLAN 106a and VLAN 106c may be switched from switch 104a to switch 104b (either based on information in L3-L2 database 110a, or because an entry for VLAN 106c did not exist in L3-L2 database 110a and the packet was switched to switch 104b because it is an intermediate switch between switch 104a and router 102). At switch 104b, an L3 bridge may be used to switch the packet to VLAN 106c if an entry for VLAN 106c exists in L3-L2 database 110b. Otherwise, if an entry for VLAN 106c does not exist in L3-L2 database 110b, the packet may be switched to switch 104c because switch 104c is an intermediate switch between switch 104b and router 102.

A component of network 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 100 without departing from the scope of the invention. The components of network 100 may be integrated or separated. Moreover, the operations of network 100 may be performed by more, fewer, or other components. Additionally, operations of network 100 may be performed using any suitable logic. As used in this document, “each” refers to each member of a set or each member of a subset of a set.

Certain embodiments of the invention may provide one or more technical advantages. A technical advantage of one embodiment may be that snooping of ARP protocol messages may permit creation of a L3-L2 database that may permit L3 bridging using L2 switches, potentially decreasing cost and complexity of a network implementation.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
creating an L3-L2 database on a first switch, the database having one or more entries, each entry: (a) associating a Level 3 (L3) unique identifier associated with a virtual local area network (VLAN) communicatively coupled to the first switch to a Level 2 (L2) unique identifier associated with the VLAN, and (b) associating the L3 unique identifier with a port of the first switch;
receiving a network packet at the first switch;
determining if a destination VLAN for the network packet has a corresponding entry in the L3-L2 database; and
switching the network packet to the port in response to a determination that the destination VLAN for the network packet has a corresponding entry in the L3-L2 database, such that the packet is communicated to one of: (a) the destination VLAN, and (b) a second switch intermediate to the first switch and the destination VLAN.

2. A method according to claim 1, further comprising switching the network packet in response to a determination that the destination VLAN for the network packet does not have a corresponding entry in the L3-L2 database, such that the packet is communicated to one of: (a) a router communicatively coupled to the first switch, and (b) a third switch intermediate to the first switch and the router.

3. A method according to claim 2, wherein the second switch and the third switch are the same switch.

4. A method according to claim 1, further comprising:
snooping address resolution protocol (ARP) packets received at the first switch; and
creating the L3-L2 database based on contents of the ARP packets.

5. A method according to claim 1, wherein the L3 unique identifier is an Internet Protocol (IP) address.

6. A method according to claim 1, wherein the L2 unique identifier is a Service VLAN address.

7. A method according to claim 1, wherein the L2 unique identifier is a Media Access Control (MAC) address.

8. A switch comprising:
logic for creating an L3-L2 database on the switch, the database having one or more entries, each entry: (a) associating a Level 3 (L3) unique identifier associated with a virtual local area network (VLAN) communicatively coupled to the switch to a Level 2 (L2) unique identifier associated with the VLAN, and (b) associating the L3 unique identifier with a port of the switch;
logic for receiving a network packet at the switch;
logic for determining if a destination VLAN for the network packet has a corresponding entry in the L3-L2 database; and
logic for switching the network packet to the port in response to a determination that the destination VLAN for the network packet has a corresponding entry in the L3-L2 database, such that the packet is communicated to one of: (a) the destination VLAN, and (b) a second switch intermediate to the switch and the destination VLAN.

9. A switch according to claim 8, further comprising logic for switching the network packet in response to a determination that the destination VLAN for the network packet does not have a corresponding entry in the L3-L2 database, such that the packet is communicated to one of: (a) a router communicatively coupled to the switch and (b) a third switch intermediate to the switch and the router.

10. A switch according to claim 9, wherein the second switch and the third switch are the same switch.

11. A switch according to claim 8, further comprising:
logic for snooping address resolution protocol (ARP) packets received at the first switch; and
logic for creating the L3-L2 database based on contents of the ARP packets.

12. A switch according to claim 8, wherein the L3 unique identifier is an Internet Protocol (IP) address.

13. A switch according to claim 8, wherein the L2 unique identifier is a Service VLAN address.

14. A switch according to claim 8, wherein the L2 unique identifier is a Media Access Control (MAC) address.

15. An apparatus comprising:
means for creating an L3-L2 database on a first switch, the database having one or more entries, each entry: (a) associating a Level 3 (L3) unique identifier associated with a virtual local area network (VLAN) communicatively coupled to the first switch to a Level 2 (L2) unique identifier associated with the VLAN, and (b) associating the L3 unique identifier with a port of the first switch;
means for receiving a network packet at the first switch;
means for determining if a destination VLAN for the network packet has a corresponding entry in the L3-L2 database; and
means for switching the network packet to the port in response to a determination that the destination VLAN for the network packet has a corresponding entry in the L3-L2 database, such that the packet is communicated to one of: (a) the destination VLAN, and (b) a second switch intermediate to the first switch and the destination VLAN.

16. An apparatus according to claim 15, further comprising means for switching the network packet in response to a determination that the destination VLAN for the network packet does not have a corresponding entry in the L3-L2 database, such that the packet is communicated to one of: (a) a router communicatively coupled to the first switch and (b) a third switch intermediate to the first switch and the router.

17. An apparatus according to claim 16, wherein the second switch and the third switch are the same switch.

18. An apparatus according to claim 15, further comprising:
means for snooping address resolution protocol (ARP) packets received at the first switch; and
means for creating the L3-L2 database based on contents of the ARP packets.

19. An apparatus according to claim 15, wherein the L3 unique identifier is an Internet Protocol (IP) address.

20. An apparatus according to claim 15, wherein the L2 unique identifier is a one of a Service VLAN address and a Media Access Control (MAC) address.
